(19) United States
(12) Patent Application Publication
(10) Pub. No.: US 2008/0262958 A1
(43) Pub. Date: Oct. 23, 2008

(54) SYSTEM AND METHOD FOR REVERSE AUCTIONING

(75) Inventors: BERNARD KU, AUSTIN, TX (US); MEHRAD YASREBI, AUSTIN, TX (US); CHAOXIN C. QIU, AUSTIN, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/738,325

(22) Filed: Apr. 20, 2007

(51) Int. Cl. G06Q 40/00

(52) U.S. Cl. 705/37

(57) ABSTRACT

A system and method for reverse auctioning is disclosed. A system that incorporates teachings of the present disclosure may include, for example, a system comprising a controller element to receive from a communication device a request for information associated with one or more commercial enterprises situated in a vicinity of a location fix of the communication device, identify information of one or more commercial enterprises that substantially match the desired commercial enterprise type and that are in the vicinity of the location fix, and transmit to the communication device information of at least one of the one or more commercial enterprises identified for purposes of engaging in a reverse auction. Additional embodiments are disclosed.

### FIELD OF THE DISCLOSURE

The present disclosure relates generally to wireless communication systems, and more specifically to a system and method for reverse auctioning.

### BACKGROUND

On-line communication systems can provide an accessible platform for exchanging information and promoting business. For example, a user can generally find directory information on local businesses by on-line means. The user can use this information to call businesses to inquire about pricing and availability of goods or services. In other arrangements, the user can browse on-line business websites and exchange text messages and emails with a business, or retrieve pricing information on-line to determine the prices of the available goods or services.

Although this approach can be useful to a consumer, it does not provide the consumer a platform for price competition between the merchants queried. A need therefore arises for a system and method for reverse auctioning.

### BRIEF DESCRIPTION OF THE DRAWINGS

FIG. 1 depicts an exemplary embodiment of a communication system;

FIG. 2 depicts an exemplary block diagram of one of several embodiments for a communication device operating in the communication system;

FIGS. 3 and 4 depict an exemplary method operating in portions of the communication system;

FIG. 5 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system and method for reverse auctioning.

In a first embodiment of the present disclosure, a computer-readable storage medium in a communication device can have computer instructions for transmitting to a system a request for information associated with one or more commercial enterprises situated in a vicinity of a location fix of the communication device. The location fix and a desired commercial enterprise type can be supplied with the request. The storage medium can also comprise computer instructions for receiving from the system information associated with one or more commercial enterprises that substantially match the desired commercial enterprise type and that are in the vicinity of the location fix, and submitting to at least one of the one or more commercial enterprises a reverse auction offer for a desired good or service.

In a second embodiment of the present disclosure, a system can have a controller element to receive from a communication device a request for information associated with one or more commercial enterprises situated in a vicinity of a location fix of the communication device. The location fix and a desired commercial enterprise type can be supplied with the request. The controller element can also identify information of one or more commercial enterprises that substantially match the desired commercial enterprise type and that are in the vicinity of the location fix, and transmit to the communication device information of at least one of the one or more commercial enterprises identified for purposes of engaging in a reverse auction.

In a third embodiment of the present disclosure, a method used by a merchant can involve receiving a reverse auction offer according to a vicinity of the merchant to a location fix of a communication device of an end user.

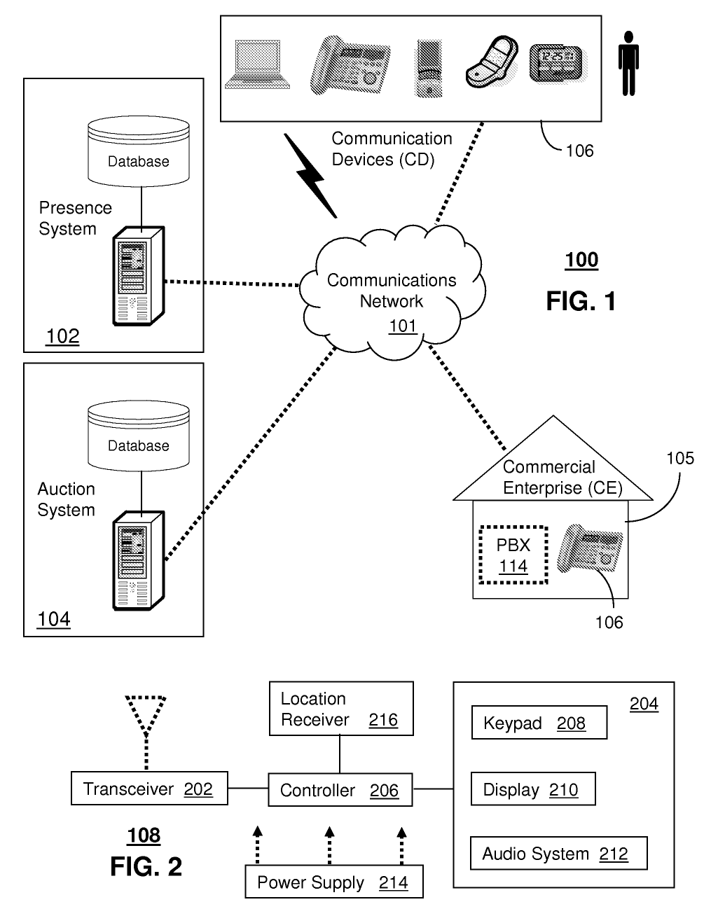

FIG. 1 depicts an exemplary embodiment of a communication system 100. The communication system 100 can comprise a presence system 102, an auction system 104, one or more communication devices 106, and one or more commercial enterprises (CEs) 105 coupled to a communication network 101. The communication network 101 can comprise a number of common network elements interconnected by wired or wireless interfaces that support packet-switched and/or circuit-switched technologies. For example, the communication network 101 can include a circuit-switched network and a packet switched (PS) network operating in part in compliance with an IP Multimedia Subsystem (IMS) architecture.

The communication network 101 can offer communication devices 106 Internet and/or traditional voice services such as, for example, POTS (Plain Old Telephone Service), VoIP (Voice over Internet communications, broadband communications, cellular telephony, as well as other known or next generation access technologies. The packet-switched network elements of the communication network 101 can utilize common technology such as MPLS (Multi-Protocol Label Switching), TCP/IP (Transmission Control Protocol), and/or ATM/FR (Asynchronous Transfer Mode/Frame Relay) for transporting Internet traffic. The CE 105 can interface to the communication network 101 by way of a PBX 114 or other common interfaces such xDSL, Cable, or satellite.

The presence system 102 can be utilized to track the whereabouts and status of a party (including merchants) communicating with one or more of the communication devices 106 in the communications network 101. Presence information derived from a presence system 102 can include a location of a party utilizing a communication device 106, the type of device used by the party (e.g., cell phone, PDA, phone, computer, etc.), and/or a status of the party (e.g., store hours, busy, offline, actively on a call, actively engaged in instant messaging, etc.). The presence system 102 can also function as a location server to determine a location fix of a communication device 106 and/or one or more CE 105. The presence system 102 can perform said operations for parties who are subscribed to services of the presence system 102.

The auction system 104 can be utilized to process a reverse auction offer originated by one or more communication devices 106. The auction server 104 can communicate with the one or more CEs 105 through the communication network 101 to exchange reverse auction related information with the communication devices 106. In one arrangement, a merchant or service provider can manage the auction server 104 for a reverse auction, and authenticate auction transactions between the one or more communication devices 106 and the one or more CEs 105. The presence and auction systems 102-104 can interact cooperatively to promote and enhance an auctioning experience for a user of the communication device or a merchant associated with the CE 105. Said systems 102-104 can also operate as an integrated unit that serves both presence and auctioning functions.

The communication devices 106 can represent any number of embodiments including without limitation a laptop or desktop computer, a POTS phone, a personal digital assistance (PDA), a cellular phone, or paging device, just to name a few. Some or all of these devices can interface to the communication network 101 with a wired or wireless interface. For example, the laptop can be interconnected to the communications network 101 by a wired Ethernet port to a DSL (Digital Service Line) interface in a residence or enterprise, or by a WiFi or WiMAX wireless connection. The POTS phone can utilize cordless 2.4 GHz or 5.8 GHz technology for short-range roaming, and interface to the communications network 101 using POTS or VoIP communications. The PDA and cellular phone can support common wireless access technologies for interfacing to the communications network 101.

Functions of the aforementioned communication devices 106 in FIG. 1 can be combined so as to create a multifunctional or multimode communication device. For example, VoIP, paging, email, calendaring, WiFi, and cellular communication functionality can be integrated into the PDA.

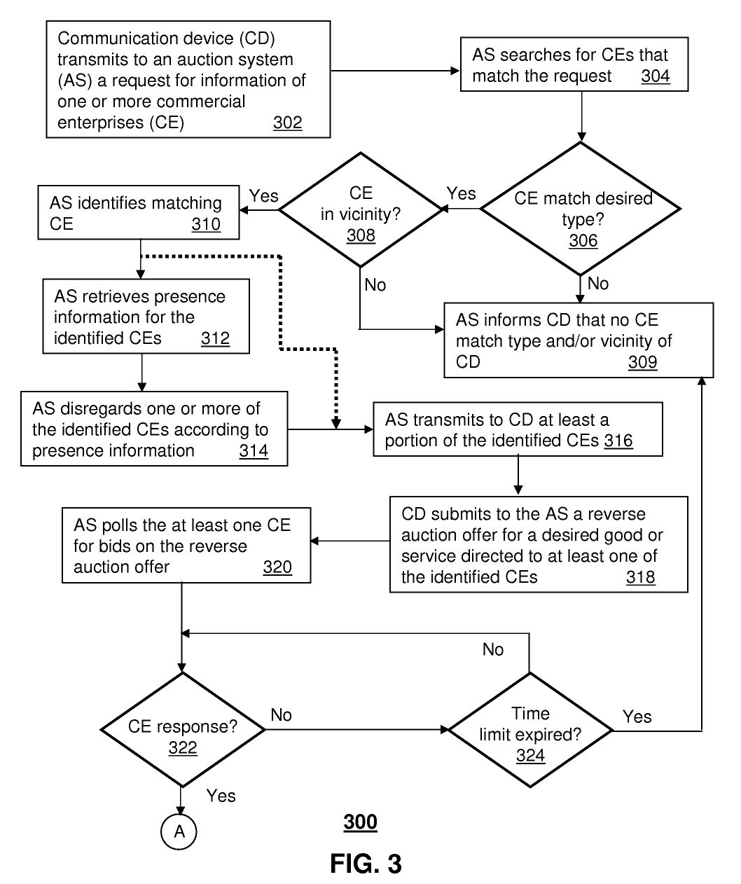

FIG. 2 depicts an exemplary embodiment of the communication device 106. A communication device 106 can comprise a wired and/or wireless transceiver 202, a user interface (UI) 204, a power supply 214, a location receiver 216, and a controller 206 for managing operations thereof. In an embodiment where the communication device 106 operates in a landline environment, the transceiver 202 utilizes common wireline access technology to support POTS or VoIP services.

In a wireless communications setting, the transceiver 202 can utilize common technologies to support singly or in combination any number of wireless access technologies including without limitation cordless phone technology (e.g., DECT), Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing a public or private communication spectrum according to any number of communication protocols that can be dynamically downloaded over-the-air to the communication device. It should be noted also that next generation wireless access technologies can be applied to the present disclosure.

The UI 204 can include a keypad 208 with depressible or touch sensitive navigation disk and keys for manipulating operations of the communication device 106. The UI 204 can further include a display 210 such as monochrome or color LCD (Liquid Crystal Display) for conveying images to the end user of the communication device, and an audio system 212 that utilizes common audio technology for conveying and intercepting audible signals of the end user.

The power supply 214 can utilize common power management technologies such as replaceable batteries, supply regulation technologies, and charging system technologies for supplying energy to the components of the communication device and to facilitate portable applications. In stationary applications, the power supply 214 can be modified so as to extract energy from a common wall outlet and thereby supply DC power to the components of the communication device 106.

The location receiver 216 can utilize common technology such as a common GPS (Global Positioning System) receiver that can intercept satellite signals and therefrom determine a location fix of the communication device 106.

The controller 206 can utilize computing technologies such as a microprocessor and/or digital signal processor (DSP) with associated storage memory such a Flash, ROM, RAM, SRAM, DRAM or other like technologies for controlling operations of the aforementioned components of the communication device.

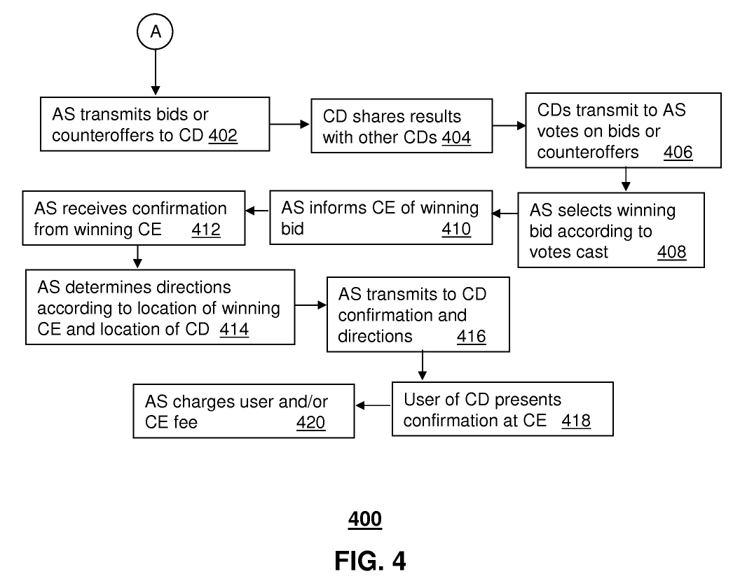

FIG. 3 depicts an exemplary method 300 operating in portions of the communication network 100. More specifically, the method 300 illustrates a means for providing a reverse auction. The method 300 can be practiced with more or less than the number of steps shown. Moreover, the method 300 is not limited to the order of steps shown. Reference will be made to FIG. 1 when describing the method 300, although it should be noted that the method 300 can be practiced in any other suitable system.

The method 300 can begin at step 302 in which a communication device (CD) 106 transmits to an auction system (AS) 104 a request for information of one or more commercial enterprises (CE) 105. The request can include a location fix of the CD 106 (e.g., GPS coordinates) and a desired commercial enterprise type. The commercial enterprise type can be a retail store type, a business type, a restaurant type, a utility type, or any other suitable type of commercial enterprise. The requested information can include identifying information for the one or more commercial enterprises and/or a description of the goods and services offered by the one or more CEs 105. As an example, a user operating the CD 106 can be at a location in a vicinity of numerous restaurants. The user can enter a restaurant type (e.g. French restaurant) in the CD 106 (by way its UI 204) to request CEs 105 within the vicinity of the CD's location. The CD 106 can include a graphical user interface (GUI) that allows the user to type in a restaurant type, a restaurant preference, or any other restaurant selection information, such as menu selection, service, wait time, price, or occupancy. The user of the CD 106 can also make a selection from a predetermined list of commercial enterprise types, such as French cuisine, Italian, fast-food, take-home, or pub-style.

At step 304, the AS 104 searches for CEs 105 using the request to identify restaurants that match the desired type (e.g. French restaurant) and location of the CD 106. To improve the efficiency of the search process, the AS 104 can include a list of commercial enterprises arranged by type that are updated on a periodic basis. The AS 104 can search the list given the restaurant type provided in the request, and categorize a list of restaurants that satisfy the requested type. In another embodiment, the request can include a plurality of enterprise types instead of just one type. For example, the user can enter a French restaurant and an Italian restaurant type, as well as other preference types.

At step 306, the AS 104 can determine if the CEs 105 that match the desired type are in the vicinity of the CD 106 in step 308. The AS 104 can utilize common location based techniques, such as Global Positioning System (GPS), to identify a location of the CD 106 and to identify restaurants within the vicinity of the CD 106. The location fix of the CD 106 can be based on a longitude and latitude coordinate or a GPS reading supplied by the location receiver 216. The term vicinity as used in the present context can correspond to a range or variable distance from the location fix (e.g., not more than 2 miles from the location fix of the CD) which can be defined by the user of the CD 106 or the AS 104. The vicinity can also correspond to a city, suburb, commercial park, residential area, district, or other commonly definable areas. If a match is not detected in step 306, and/or the CE 105 is not in the vicinity of the CD 106, the AS 104 proceeds to step 309 where it informs the CD 106 that no CEs 105 were found that matched the commercial type requested, and/or that the CEs 105 found were not in the vicinity of the CD 106.

At step 310, the AS 104 identifies the CEs 105 that satisfy the commercial enterprise type presented in the request and that are within the vicinity of the CD 106. The AS 104 can respond to the CD 106 with information that identifies a name of the enterprise (e.g. restaurant name), goods or services offered (e.g. menu selection), store hours (e.g. 12-5PM), and current discounts offered (e.g. buy an entree receive a free appetizer). In one embodiment, the AS 104 can also retrieve presence information for the identified CEs 105, as shown in step 312 from the presence system 102. The presence system 102 can supply information that can be relevant to selecting a CE 105. The presence system 102 can also provide information associated with each of the one or more restaurants such as a consumer opinion report of an independent third party, and/or a consumer opinion report of friends or family of an end user of the CD 106. The reports can provide opinions on the desired goods or services offered by the one or more CEs 105. The presence system 102 can retrieve the reports associated with friends and family using a communication identifier, such as a phone number, of the CD 106. The communication identifier can thus be used as a means for associating the user of the CD 106 with a subscribed account that contains the reports from said friends and family.

The presence information along with the consumer report(s) can be used by the AS 104 to disregard one or more of the identified CEs 105 as shown in step 314. As an example, the information retrieved from the presence system 102 can identify a time of the request, and determine if any of the identified restaurants are open, or are open for a reasonable amount of time in view of the request time. For instance, if the request is made at 6:59PM, the AS 104 can be programmed to respond with restaurants that will remain open for at least one more hour, as specified in the presence information, such as those that close at 8PM or later, thereby allowing the requesting party to have at least one hour for dining. The AS 104 can also be programmed to account for the location and driving time of the user of the CD 106.

In step 316, the AS 104 transmits to the CD 106 at least a portion of the identified CEs 105 not filtered by step 314 with corresponding information for each CE. For example, the AS 104 responds with a list of French restaurants with their name, location, menu, seating availability, specials and so on within a radius of 5 miles that are open for the next hour and possibly a list of ratings for the French restaurants from friends and family, and or third party consumer rating companies (e.g., Consumer Reports™). Upon reviewing this information, the user can at step 318, direct the CD 106 to submit to the AS 104 a reverse auction offer for a desired good or service directed to at least one of the identified CEs 105. The reverse auction offer can be a request for receiving bids from the one or more CEs 105 for the desired goods or services identified by the user. The bid can identify a desired price of the good or service. For example, upon receiving the list of French restaurants, the user of the CD 106 can select one or two medium price category restaurants (e.g. ˜$35 per person) and enter a reverse auction offer. The reverse auction offer can identify a number of parties (e.g. 8 people) involved and an estimated dinner budget ($20×8 people=$160).

Upon receiving the reverse auction offer from the CD 106, the AS 104 can forward the offer to the list of restaurants selected by the user within the vicinity of the CD 106 that matched the restaurant type and location criteria requested. At step 320, the AS 104 can poll at least one CE 105 for bids on the reverse auction offer. In the continuing example, the AS 104 presents the information (e.g. $160 dinner budget price) provided by the user in the reverse auction offer to the list of selected restaurants for soliciting a bid from the selected restaurants. The merchants associated with the restaurants can each individually assess the offer and respond accordingly with a bid corresponding to an acceptance or counteroffer, if so desired. For example, a restaurant can determine if they are willing to provide the service at the price of the reverse auction offer ($160 for 8 people), counter the reverse auction offer with a bid of $170 for a party of 8 instead of matching the $160 offer to win the bid, or simply not respond at all.

The restaurants can each utilize an automated computing resource coupled to the communications network 101 to engage in the bidding process until a certain price is accepted. For example, a first restaurant can establish a per person minimum of $25 per person. In contrast, a second restaurant, can accept a per person minimum of $20 per person as a function of the time, date, and capacity. The automated resources of the merchant can also provide an option to manually override a reverse auction profile established by the merchant. For example, a hostess or manager of the restaurant can override the bid price generated by said resource in view of the current occupancy or wait time. In yet another embodiment, a merchant of the restaurant can outsource the reverse auctioning process to a third party web service that responds with a predetermined bidding profile established by the merchant.

The AS 104 can impose a time limit for responding to the reverse auction offer, as shown in step 324, and only accept responses that are submitted within the time limit. For example, a user can present a reverse auction offer at 5PM for a 7PM dinner reservation. The AS 104 can establish the time limit with respect to the time of the offer (e.g. 15 minutes after 5PM), with respect to the time of the reservation (e.g. 30 minutes before 7PM), or other suitable criteria established by the user submitting the reverse auction offer. In such regard, the AS 104 can accept bids from CEs 105 for consideration only within the allotted time limit. If no restaurants respond within the time limit, the AS 104 can inform the user at step 309 that no CEs 105 responded to the reverse auction within the specified time limit.

When a CE 105 responds with an acceptance or a counteroffer in step 322, the AS 104 can present the response to the CD 106 as shown in step 402 of FIG. 4. Bids from multiple CEs 105 can be presented by way of the UI 204 of the CD 106, and responded to by the user by said means. The CD 106 can present the bids in descending order, in alphabetical order, wait time order, menu rating order, or using any other suitable sorting method for presenting the auction results to the user. The AS 104 can also share the acceptance or counteroffer with other CEs 105 engaged in the reverse auction offer, thereby allowing the other CEs 105 to see acceptances or competing counteroffers entered in the reverse auction. This is advantageous to the user since the identified restaurants can negotiate lower prices in view of competing bids for attracting the user's business.

In one aspect, a counteroffer can be a new offer from a selected CE 105 that at least matches in part or surpasses, in favor of the user, the reverse auction offer. For example, a first restaurant can bid $180 for the reverse auction, and a second restaurant, upon seeing the bid, can counter the offer with a lower $170 bid. In another aspect, a counteroffer can be an offer, with a price adjustment, presented by the user upon receiving the bids in the reverse auction offer. For example, upon receiving bids from all the identified restaurants, the user can determine that a higher price of $165 is warranted based on none of the CEs 105 responding with an acceptance of the reverse auction offer of $160.

The AS 104 can also transmits bids and/or counteroffers to other CDs 106, such as those operated by friends and family of the user, engaged in the reverse auction, as shown in step 404. The AS 104 can send bids to the CD 106 upon newly submitted bids, which the CD 106 can then share with the other CDs 106 (e.g. friends and family). The CD 106 can send the current bids, a history of the bids, and the items for sale (e.g. menu selection) under reverse auction to other CDs 106. This allows the user initiating the reverse auction to share bidding results with other parties, such as family or friends, who have an involvement or interest in the reverse auction.

The CD 106 can audibly and visually inform the user of new bids as they are supplied by the AS 104, for example, using common techniques such as text messaging or speech synthesis. The CD 106 can inform the user of the lowest bid via a text message and ask the user if the bid is agreeable. The user can forward the bid to the other parties as directed by the user of said CD 106, or the CD 106 can be configured to automatically share the results with other users on a ‘buddy list’. Recall, the presence system 102 can include consumer reports on the one or more CEs 105 which can be accessed using a telephone number of a CD 106. Participants in the reverse auction can review the consumer reports for bidding CEs 105.

Upon the CD 106 sharing the bidding results, other users engaged in the reverse auction can then vote on the bids. As shown in step 406, the CDs 106 can transmit to the AS 104 votes on bids or counteroffers. At step 408, the AS 104 can accept a winning bid according to the votes cast. In one arrangement, the winning bid can be chosen based on the AS 104 receiving a majority of votes for a given bid or counteroffer. In another arrangement, the user initiating the reverse auction can override the votes and select a winning bid. At step 410, the AS 104 can respond to each CE 105 engaged in the reverse auction with information concerning the winning bid, such as the bid price and the items auctioned (e.g. menu list tendered). This allows the CEs 105 to update their bidding profiles to assess competitor prices and items in forming an acceptance or a counteroffer response in future reverse auctions.

At step 412, the AS 104 can request and receive confirmation from the winning CE 105. The winning CE 105, upon receiving notification that they submitted the accepted bid, can provide address information to the AS 104. Alternatively, the AS 104 can look-up an address of the winning CE 105 and determine directions according to the location of winning CE 105 and a location fix of the CD 106 by way of its location receiver 216, as shown in step 414. The AS 104 can generate directions for the CD 106 initiating the reverse auction and other parties associated with the reverse auction. For example, the AS 104 can generate a first set of directions to the winning restaurant for a first CD 106 with respect to a location of the first CD, and a second set of directions for a second CD with respect to a location of the second CD, and so on. The AS 104 can then proceed in step 416 to transmit to the CD 106 a confirmation of acceptance by the winning CE 105, and a set of directions and contact information displayable on the CD 105. The directions can present a map of the vicinity and instructions for reaching the restaurant from the location fix of the CD 106.

The user of the CD 106, at step 418, upon following the directions to the CE 105, can present the confirmation to the CE 105. The confirmation can include a receipt identifying the winning bid and/or an authorization of acceptance by the restaurant which can include a logo of the restaurant or the reverse auction which the merchant can use to authenticate the user. The user can present the confirmation via visual display of the CD 106, or via a wireless connection to a hostess of the winning restaurant to show that the user is the initiator or a participant of the reverse auction offer. In another example, the CD 106 can transmit the confirmation via a Radio Frequency Identification (RFID) to a RFID reader system in the restaurant. The user can hold the CD 106 to the RFID reader which wirelessly reads the confirmation from the CD 106 and authorizes the sale of the good or service at the agreed upon price. In yet another arrangement, the CD 106 can present the confirmation through a Bluetooth wireless connection to a server equipped for Bluetooth communication in the restaurant.

Upon the CD 106 presenting the confirmation at the CE 105, the AS 104 at step 420 can be programmed to charge the user and/or the CE 105 a service fee for services rendered in the reverse auction. In one arrangement, the CD 106 upon receiving an acknowledgment receipt for the confirmation from the CE 105 for the purchase of the good or service can supply the AS 104 a copy of the receipt. The AS 104 can proceed to apply a service charge to the user's billing statement and/or send an additional bill to the winning CE 105 for another service charge. In another arrangement, the CE 105 can be required to authorize the confirmation through the AS 104, thereby automatically informing the AS 104 that the reverse auction has been closed. The AS 104 can proceed to bill the winning CE 105 for services rendered in response to the authorization. The AS 104 can also elect to not to charge the non-winning CE's for service fees associated with the reverse auction. In such regard, only the winning CE 105 incurs a service charge, which can be a percentage of the agreed reverse auction price. The AS 104 does however retain privileges for setting service fees, and can charge non-winning CEs 105 for services rendered.

Upon reviewing the embodiments disclosed, it would be evident to an artisan with ordinary skill in the art that said embodiments can be modified, reduced, or enhanced without departing from the scope and spirit of the claims described below. For example, the functions described for the auction system 104 can be integrated in whole or in part with the CD 106. Method 300 can be modified so that instead of one reverse auction offer, the CEs 105 can supply multiple reverse auction offers. The AS 104 can supply said offers to the CEs 105 which can react with one or more acceptances or counteroffers for each offer. The AS 104 can in response perform a sorting function that simplifies the presentation of the responses given by the CEs 105. Although focus has been placed for illustration purposes on restaurants, reverse auction offers can be applied in other contexts. For example, the user can submit a reverse offer auction for a utility service, such as a temporary WiFi connection pass, or a product, such as a movie ticket, an airline reservation, or a service, such as a hotel reservation.

Other suitable modifications can be made to the present disclosure. Accordingly, the reader is directed to the claims below for a fuller understanding of the breadth and scope of the present disclosure.

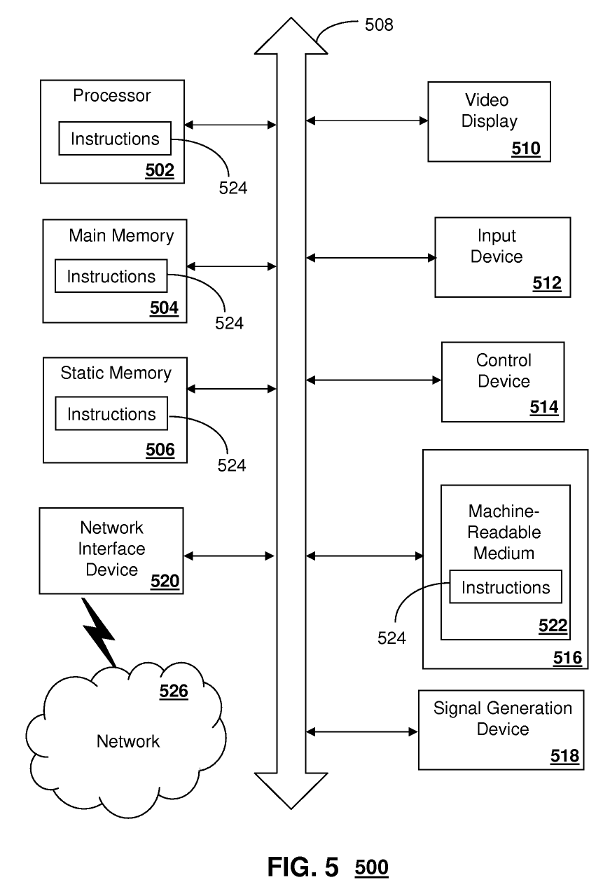

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a mass storage medium 516, a signal generation device 518 (e.g., a speaker or remote control) and a network interface device 520.

The mass storage medium 516 may include a computer-readable storage medium 522 on which is stored one or more sets of instructions (e.g., software 524) embodying any one or more of the methodologies or functions described herein, including those methods illustrated above. The computer-readable storage medium 522 can be an electromechanical medium such as a common disk drive, or a mass storage medium with no moving parts such as Flash or like non-volatile memories. The instructions 524 may also reside, completely or at least partially, within the main memory 504, the static memory 506, and/or within the processor 502 during execution thereof by the computer system 500. The main memory 504 and the processor 502 also may constitute computer-readable storage media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the computer-readable storage medium 522 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable storage medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a computer-readable storage medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a communication device, comprising computer instructions for:
transmitting to a system a request for information associated with one or more commercial enterprises situated in a vicinity of a location fix of the communication device, wherein the location fix and a desired commercial enterprise type is supplied with the request;
receiving from said system information associated with one or more commercial enterprises that substantially match the desired commercial enterprise type and that are in the vicinity of the location fix; and
submitting to at least one of said one or more commercial enterprises a reverse auction offer for a desired good or service.

2. The storage medium of claim 1, wherein the system is at least one among a location system and an auction system.

3. The storage medium of claim 1, wherein the enterprise type is at least one among a retail type, a restaurant type, and a utility type.

4. The storage medium of claim 1, wherein the location fix is based on a longitude and latitude coordinate or a Global Positioning System (GPS) reading.

5. The storage medium of claim 1, wherein the vicinity corresponds to a range from the location fix.

6. The storage medium of claim 1, wherein the information received from the system identifies at least one among a name of an enterprise, goods or services offered, store hours, available seating, and current discounts offered.

7. The storage medium of claim 1, wherein the information associated with each of the one or more commercial enterprises comprises at least one among a consumer opinion report of an independent third party, and a consumer opinion report of friends or family of an end user of the communication device, wherein said reports provide opinions on the desired goods or services offered by the one or more commercial enterprises.

8. The storage medium of claim 7, comprising computer instructions for retrieving the consumer opinion reports of friends and family according to a communication identifier associated with the communication device.

9. The storage medium of claim 1, comprising computer instructions for receiving a bid from each of at least one of the one or more commercial enterprises responsive to the reverse auction offer, wherein the bid identifies a price for the desired good or service.

10. The storage medium of claim 9, comprising computer instructions for receiving votes from multiple parties engaged in said reverse auction offer and accepting a winning bid according to the votes cast.

11. The storage medium of claim 10, comprising computer instructions for receiving a confirmation for the winning bid from the commercial enterprise submitting the winning bid.

12. The storage medium of claim 11, wherein the confirmation includes at least one among a reservation, a receipt, a map, and directions.

13. The storage medium of claim 9, comprising computer instructions for receiving a counteroffer from each of at least one of the one or more commercial enterprises responsive to the reverse auction offer.

14. The storage medium of claim 13, comprising computer instructions for receiving votes from multiple parties engaged in said reverse auction offer and accepting one of the counteroffers according to the votes cast.

15. A system, comprising a controller element to:
receive from a communication device a request for information associated with one or more commercial enterprises situated in a vicinity of a location fix of the communication device, wherein the location fix and a desired commercial enterprise type is supplied with the request;
identify information of one or more commercial enterprises that substantially match the desired commercial enterprise type and that are in the vicinity of the location fix; and
transmit to the communication device information of at least one of the one or more commercial enterprises identified for purposes of engaging in a reverse auction.

16. The system of claim 15, wherein the controller element:
receives from the communication device a reverse auction offer for a desired good or service directed to at least one of the one or more commercial enterprises; and
transmits said reverse auction offer to the at least one of the one or more commercial enterprises.

17. The system of claim 16, wherein the controller element:
receives a bid from at least one of the one or more commercial enterprises responsive to the reverse auction offer, wherein the bid identifies a price for the desired good or service; and
transmits to the communication device the bid of each of the at least one of the one or more commercial enterprises.

18. The system of claim 17, wherein the controller element receives votes from multiple parties engaged in the reverse auction offer, informs the multiple parties of an accepted winning bid according to the votes cast, and notifies the commercial enterprise associated with the winning bid.

19. The system of claim 18, wherein the controller element transmits a confirmation to multiple parties engaged in the reverse auction offer from the commercial enterprise submitting the winning bid, wherein the confirmation includes at least one among a reservation, a receipt, a map and directions.

20. The system of claim 16, wherein the controller element receives a counteroffer from at least one of the commercial enterprises responsive to the reverse auction offer.

21. The system of claim 20, wherein the controller element receives votes from multiple parties engaged in said reverse auction offer, accepts one of the counteroffers according to the votes cast, and notifies the commercial enterprise associated with the accepted counteroffer.

22. The system of claim 17, wherein the controller element receives from the communication device an acceptance of one of the bids.

23. The system of claim 22, wherein the controller element informs the commercial enterprise of the acceptance for the winning bid.

24. The system of claim 23, wherein the controller element:
receives a confirmation from the commercial enterprise;
determines directions to the commercial enterprise according to a known location of the commercial enterprise and the location fix; and
transmits to the communication device the confirmation with directions to the commercial enterprise.

25. The system of claim 15, wherein the system corresponds to at least one among a location system, and an auction system.

26. The system of claim 15, wherein the controller element:
retrieves presence information for each of the one or more commercial enterprises that match the desired commercial enterprise type and that are in the vicinity of the location fix;
disregards according to the presence information at least one of the commercial enterprises identified; and
transmits to the communication device information of the one or more commercial enterprises except the one or more commercial enterprises that have been disregarded.

27. A method used by a merchant, comprising receiving a reverse auction offer according to a vicinity of the merchant to a location fix of a communication device of an end user.

28. The method of claim 27, wherein the reverse auction offer comprises a request for a desired good or service at a desired price.

29. The method of claim 28, comprising transmitting to the communication device an acceptance and confirmation of the reverse auction offer.

30. The method of claim 28, comprising transmitting to the communication device a counteroffer to the reverse auction offer.

31. The method of claim 29, comprising being presented with the confirmation by an end user of the communication device.

32. The method of claim 29, comprising being charged a fee by a system for accepting the reverse auction offer.
